(19) United States
(12) Patent Application Publication
(10) Pub. No.: US 2014/0223321 A1
(43) Pub. Date: Aug. 7, 2014

(54) PORTABLE DEVICE AND METHOD FOR CONTROLLING EXTERNAL DEVICE THEREOF

(71) Applicant: SAMSUNG ELECTRONICS CO., LTD., Suwon-si (KR)

(72) Inventors: Sung-hyuk KWON, Suwon-si (KR); Jung-hoon SHIN, Hwaseong-si (KR); Bum-jin LEE, Goyang-si (KR)

(73) Assignee: SAMSUNG ELECTRONICS CO., LTD., Suwon-si (KR)

(21) Appl. No.: 14/171,193

(22) Filed: Feb. 3, 2014

(30) Foreign Application Priority Data
Feb. 6, 2013 (KR) 10-2013-0013457

(51) Int. Cl. G06F 3/0482; G06F 3/0481

(52) U.S. Cl. CPC G06F 3/0482; G06F 3/04817
USPC 715/740

(57) ABSTRACT

A method for controlling a portable device and an external device thereof is provided. When a preset user command is input while a portable device is in a lock mode, the portable device displays a remote control UI which controls an external device, and performs pairing with the external device based on the remote control UI to control the external device.

### CROSS-REFERENCE TO RELATED APPLICATIONS

This application claims priority from Korean Patent Application No. 10-2013-0013457, filed in the Korean Intellectual Property Office on Feb. 6, 2013, the disclosure of which is incorporated herein by reference.

### BACKGROUND

1. Field

Methods and apparatuses consistent with the exemplary embodiments relate to a portable device and the controlling of an external device, and more particularly, to a portable device which may be used as a remote control to control an external device.

2. Description of the Related Art

Generally, users may control a display device by using a remote control to perform various functions. In the past, remote controls were designed to exclusively control a display device. However, with development of communication technologies, portable devices such as smartphones may function as a remote control and may control a display device.

The controlling of a display device by using a smartphone requires the installation of an exclusive application into the smartphone. Furthermore, in order to use the remote control while watching the display device, a lock mode release screen would have to be displayed and then the lock mode released using the screen. The exclusive application would be found from an execution screen. In other words, since multiple steps have to be embodied before using the remote control, the ability to control the display device immediately would be impossible.

In addition, when the exclusive application is closed, the application would have to be re-executed to control a display device.

### SUMMARY

An aspect of the exemplary embodiments is designed to solve the above-stated problems and provides a portable device with increased user convenience and a method for controlling an external device thereof, by providing a remote control user interface (UI) as a lock mode release screen.

A method for controlling an external device of a portable device according to an exemplary embodiment includes, when a preset user command is input while the portable device is in a lock mode, displaying a remote control UI which controls the external device; and performing pairing with the external device in order to control the external device by using the remote control UI.

According to an aspect of the exemplary embodiments the method may further include, when a user command is input by the remote control UI to release a lock mode, releasing a lock mode of the portable device and displaying an execution screen.

According to another aspect of the exemplary embodiments, the remote control UI may include a number icon, wherein, when the user inputs a preset pattern into the number icon of the remote control UI, a lock mode of the portable device may be released, and an execution screen displayed.

According to another aspect of the exemplary embodiments, the remote control UI may include a number icon, wherein when a preset password is input into a number icon of the remote control UI, a lock mode of the portable device may be released and an execution screen displayed.

According to aspect of the exemplary embodiments, the displaying may include, when a preset user command is input while the portable device maintains a lock mode, a first displaying which displays an icon for displaying a lock mode release screen and the remote control UI, and when the icon is selected, a second displaying which changes a lock mode release screen of the portable device to the remote control UI and displays the same.

According to another aspect of the exemplary embodiments, the performing may include searching the external device to be controlled; when the external device to be controlled is detected, transmitting a pairing request to the searched external device; when a signal responding to the pairing request is received from the searched external device, performing pairing with the searched external device.

According to another aspect of the exemplary embodiments, the method may include, when the searched external device is an external device which is searched for a first time, displaying a message asking whether to perform pairing with the external device.

According to another aspect of the exemplary embodiments, the performing may include, when a plurality of external devices are searched, displaying a list including the searched plurality of external devices; and when one of the plurality of external devices on the list is selected, performing pairing with the selected external device.

In addition, the method may include, when a user command is input into the remote control UI, transmitting a control signal corresponding to the user command to the paired external device.

According to another aspect of the exemplary embodiments, the method may include, when the external device is a television (TV), the remote control UI may include at least one of a number icon, a channel control icon, a volume control icon, and a power icon.

According to an exemplary embodiment, a portable device includes a display which comprises a touch panel; a communication device configured to communicate with an external device; an input configured to receive a user command; and a controller, configured to, when a preset user command is input through the input while the portable device maintains a lock mode, control the display to display a remote control user interface (UI) which is configured to control the external device, and configured to control the communication device to perform pairing with the external device to control the external device using the remote control UI.

The controller, when a user command is input to release a lock mode using the displayed remote control UI, is configured to control the display to release a lock mode of the portable device and display an execution screen.

According to another exemplary embodiment, the remote control UI includes a number icon, wherein the controller, when a user inputs a preset pattern into a number icon of the remote control UI, controls the display to release a lock mode of the portable device and display an execution screen.

According to another exemplary embodiment, the remote control UI comprises a number icon, wherein the controller, when a user inputs a preset pattern into the number icon of the remote control UI, controls the display to release a lock mode of the portable device and display an execution screen.

According to another exemplary embodiment, when a preset user command is input through the input while the portable device maintains a lock mode, the controller controls the display to display an icon for displaying a lock mode release screen and a remote control UI, and when the displayed icon is touched, controls to change a lock mode release screen of the portable device to the remote control UI and display the remote control UI.

According to another aspect of the exemplary embodiments, when a preset user command is input, the controller controls the display to search for the external device to be controlled, and when the external device to be controlled is detected, transmit a pairing request to the searched external device, and when a signal responding to the pairing request is received from the searched external device, control to perform a pairing with the searched external device.

According to another aspect of the exemplary embodiments, when the searched external device is an external device searched for a first time the controller may control the display to display a message asking whether to perform pairing with the external device searched for the first time.

According to another aspect of the exemplary embodiments, when a plurality of external devices are searched, the controller may control the communication device to display a list including the searched plurality of external devices, and when one of the plurality of external devices on the list is selected, perform pairing with the selected external device.

According to another aspect of the exemplary embodiments, when a plurality of external devices are searched, the controller may control the communication device to display a list including the searched plurality of external devices, and when one of the plurality of external devices on the list is selected, perform a pairing with the selected external device.

According to another aspect of the exemplary embodiments, when a user command is input into the remote control UI the controller may control to transmit a control signal corresponding to the user command to the paired external device.

According to another aspect of the exemplary embodiments, when the external device is TV, the remote control UI may include at least one of a number icon, a channel control icon, a volume control icon, and a power icon.

### BRIEF DESCRIPTION OF THE DRAWINGS

The above and/or other aspects will be more apparent by describing certain exemplary embodiments with reference to the accompanying drawings, in which:

FIG. 1 is a view illustrating a system which includes a portable device and an external device thereof according to an exemplary embodiment;

FIG. 2 is a view illustrating a block diagram of the configuration of a portable device;

FIG. 3 is a view illustrating a block diagram which illustrates the configuration of a portable device in detail according to an exemplary embodiment;

FIG. 4 is a view illustrating a remote control UI according to an exemplary embodiment;

FIG. 5 is a view illustrating a lock mode release screen according an exemplary embodiment;

FIG. 6A and FIG. 6B are views illustrating a method to release a lock mode using a remote control UI according to an exemplary embodiment; and

FIG. 7 is a view illustrating a flowchart to explain a method to control an external device of a portable device according to an exemplary embodiment.

### DETAILED DESCRIPTION OF EXEMPLARY EMBODIMENTS

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

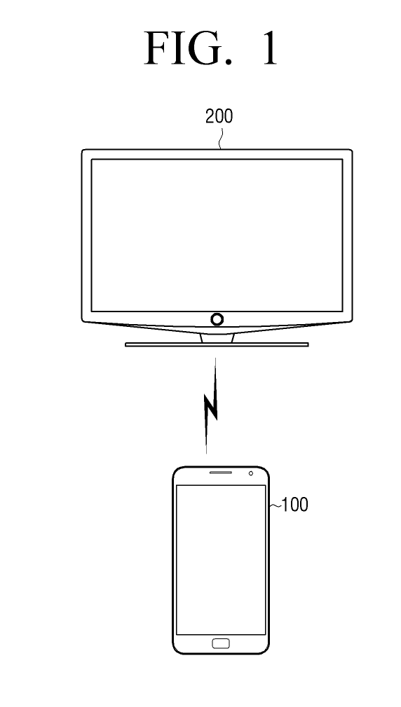

FIG. 1 is a view illustrating a system which includes a portable device 100 and an external device 200 according to an exemplary embodiment.

The portable device 100 is a device which may perform various functions such as a communication function, a content display function, and a web page providing function, and so on. In particular, according to an exemplary embodiment, the portable device 100 provides a function to control the external device 200.

Specifically, when the portable device 100 maintains a lock mode, and a preset user command (for example, a user command to select a preset external button) is input, the portable device 100 displays a remote control UI which may control the external device 200. The portable device 100, in order to control the external device 200 by using the remote control UI, performs a pairing with the external device 200. For example, when the external device 200 is a TV, the portable device 100 may display a remote control UI which includes at least one of a number icon, a channel control icon, a volume control icon, and a power icon.

The portable device 100 performs pairing with the external device 200 to control the external device 200. Specifically, the portable device 100 may search or determine whether or not the external device 200 exists within the network, and transmit a pairing request to the searched external device 200. When a signal responding to the pairing request is received from the searched external device 200, the portable device 100 may perform pairing with the external device 200.

When a user command is input using the remote control UI displayed on the portable device 100, the portable device 100 may generate a control signal which corresponds to a user command and transmit the control signal to the external device 200. For example, when a channel control icon selected through the remote control UI is selected, the portable device 100 generates the control signal to perform a channel change function which corresponds to the selected channel control icon and transmits the signal to the external device 200.

The overall functions of the external device 200 may be controlled according to the control signal received from the portable device 100. For example, when the external device 200 is a TV, if the control signal received from the portable device 100 is a channel change signal, the external device 200 performs a channel change function according to the control signal.

The remote control UI displayed on the portable device 100 may control the external device 200 and also simultaneously function as a screen to release a lock mode of the portable device 100. For example, when a preset password or a pattern is input through the remote control UI, the portable device 100 may release a lock mode of the portable device 100 and display an execution screen.

By the above-described system, a user, even if there is no remote control available, may control the external device 200 immediately by using the portable device 100.

The portable device 100 according to an exemplary embodiment may be embodied as a smartphone, but this is merely exemplary, and the portable device may be embodied as various portable devices which may perform communication such as a MP3 player and a tablet PC, etc.

According to an exemplary embodiment, the external device 200 may be embodied as TV, but this is merely exemplary, and the external device may be embodied as various external devices to be controlled by a remote control such as an audio apparatus and an air-conditioner, etc.

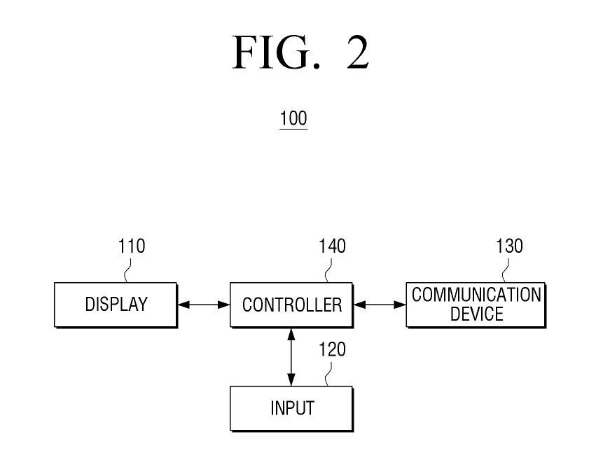

Hereinbelow, by referring to FIG. 2 to FIG. 6B, according to an exemplary embodiment, the portable device 100 will be explained. FIG. 2 is a view illustrating a block diagram which briefly illustrates the configuration of the portable device 100. As illustrated in FIG. 2, the portable device 100 includes a display 110, an input 120, a communication device 130, and a controller 140 according to an exemplary embodiment.

The display 110 displays a video data input on the portable device 100. In particular, when a preset user command is input in a lock mode, the display 110 may display one of the lock mode release screen or the remote control UI. In this case, the display 110 includes a touch panel, and the touch panel may transmit the detected touch command to the controller 140.

The input 120 receives a user command to control the portable device 100. In particular, the input 120, in a lock mode, may receive a user command for the display 110 to display a remote control UI. In this case, the input 120 may be a button installed outside of the portable device 100.

The communication device 130 communicates with an external electronic apparatus (for example, a server and an external apparatus). In particular, the communication device 130 may communicate with the external device 200 so that the portable device 100 may control the external device 200. In this case, the communication device 130 may be embodied as one of a Bluetooth interface, a Zigbee interface, and a Wi-Fi interface.

The controller 140 controls overall operations of the portable device 100 according to a user command input through a touch panel of the display 110 and the input 120.

When a user command is not input for a preset time (for example, 1 minute), the controller 140 maintains a lock mode of the portable device 100. In this case, as for a lock mode of the portable device 100, a power supply is blocked for the remaining configurations (for example, a display) other than the configurations playing essential functions (for example, a communication function, etc.) of the portable device 100. Accordingly, when a lock mode of the portable device 100 is maintained, the controller 140 may control the display 110 so that videos are not displayed on a display screen.

When a preset user command is input through the input 120 while the portable device 100 maintains a lock mode, the controller 140 controls the display 110 to display the remote control UI which may control the external device 200. By way of example, when the external device 200 is a TV, the controller 140 may control the display 110 to display the remote control UI which includes at least one of a number icon, a channel control icon, a volume control icon, and a power control icon.

The controller 140, in order to control the external device 200 using the remote control UI, controls the communication device 130 to perform pairing with the external device 200. Specifically, when a preset user command is input, the controller 140 searches for an external device to be controlled. When the external device to be controlled is detected, controller 140 may control the communication device 130 to transmit a pairing request to the searched external device. When a signal responding to the pairing request is received from the searched external device, the controller 140 may control the communication device 130 to perform pairing with the searched external device.

When a user touch command is input into the remote control UI displayed on the display 110, the controller 140 may control the communication device 130 to transmit a control signal corresponding to a user command to the paired external device 200.

The controller 140 may perform a function to release a lock mode of the portable device 100 as well as a function to control the external device 200 by using the remote control UI. Specifically, when a user command to release a lock mode using the displayed remote control UI is received, the controller 140 may control the display 110 to release a lock mode of the portable device 100 and display an execution screen. For example, when a number icon is included in the remote control UI, if successive user touches with a preset pattern or password is input into a number icon of the remote control UI, the controller 140 may control the display 100 to release a lock mode of the portable device 100 and display an execution screen.

According to an exemplary embodiment, when a preset command is input, the controller 140 controls the display 110 to display the remote control UI directly. However, this is merely exemplary, and when a preset command is input, the controller 140 may display a screen to release a lock mode preferentially, and then control the display 110 to display the remote control UI based on a choice by a user. Specifically, while the portable device maintains a lock mode, when a preset user command is input by the input 120, the controller 140 may control the display 110 to display a screen to release a lock mode and an icon to display the remote control UI. When the displayed icon is touched, the controller 140 may control the display 110 to change a screen to release a lock mode of the portable device 100 into the remote control UI and display it.

As explained above, by displaying the remote control UI by the portable device 100, a user may immediately control the external device 200 using the remote control UI, if necessary, or release a lock mode.

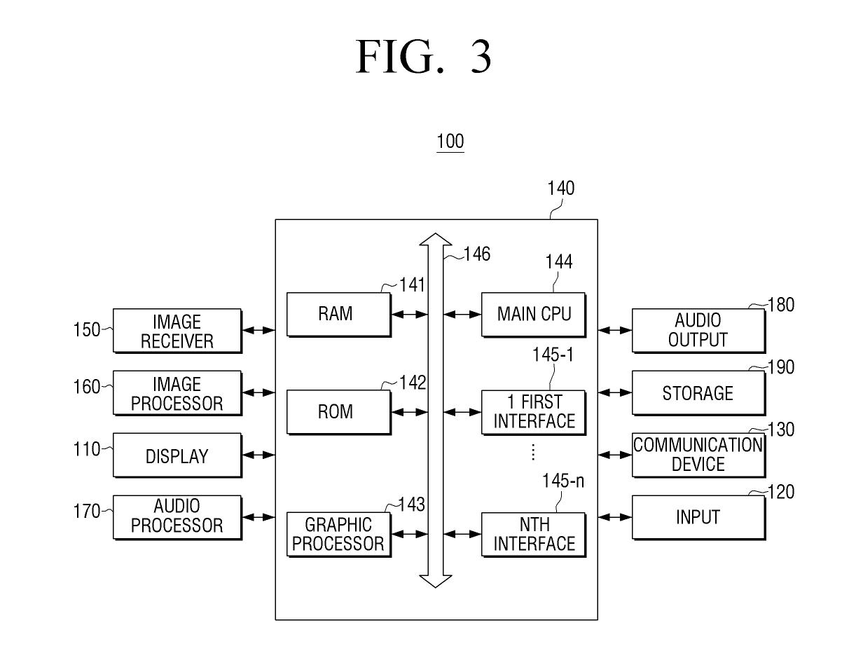

FIG. 3 is a view illustrating a block diagram which describes the components of the portable device 100 according to an exemplary embodiment. As illustrated in FIG. 3, the portable device 100 includes the display 110, the input 120, the communication device 130, the controller 140, an image receiver 150, an image processor 160, an audio processor (170), an audio output 180, and storage 190.

FIG. 3 is a view illustrating various configurations by way of an example of the portable device 100 which is equipped with various functions such as a communication function, a video play function, and a display function. Accordingly, according to an exemplary embodiment, a part of the components illustrated in FIG. 3 may be omitted or changed, or other components may be added.

The image receiver 150 receives video data through various sources. For example, the image receiver 150 may receive broadcasting data from an external broadcasting station, real-time video data from an external server, and video data stored in an internal storage 190.

The image processor 160 is a component which processes video data received in the image receiver 150. The image processor 160 may perform various image processes such as decoding of video data, scaling, noise filtering, frame rate conversion, and resolution conversion, etc.

The display 110 displays at least one video data received from the image receiver 150 among a video frame processed by the image processor 160 and various screens generated by a graphic processor 143. Particularly, the display 110 may display the remote control UI to control a screen to release a lock mode or the external device 200.

An audio processor 170 is a component which processes audio data. In the audio processor 170, various processes such as decoding of audio data, amplification, noise filtering, etc. may be performed. Audio data processed in the audio processing unit 170 may be outputted to an audio output (180).

An audio output 180 is a configuration to output various alarm sounds or audio messages as well as various audio data processed by the audio processor 170. In this case, the audio output 180 may be embodied as a speaker, but this is merely exemplary, and the audio output may be embodied as an audio terminal.

Storage 190 may store various modules to run the portable device 100. For example, the storage 190 may store software that includes a base module, a sensing module, a communication module, a presentation module, a web browser module, and a service module. In this case, a base module may be a fundamental module which processes signals delivered from each hardware included in the portable device 100 and delivers such signals to an upper layer module. A sensing module is a module which collects information from various sensors, and analyzes and manages collected information, which may include a face recognition module, an audio recognition module, a motion recognition module, and a Near Field Communication (NFC) recognition module. A presentation module is a module to compose a display screen and may include a multimedia module to display and input multimedia contents and a UI rendering module which proceeds UI and graphic processing. A communication module is a module to communicate with an external device. A web browser module indicates a module to perform web browsing and accesses to a web server. A service module is a module which includes various applications to provide various services.

As described above, the storage 190 may include various program modules. In this case, various program modules may be omitted in part, transformed, or added according to a type and a feature of the portable device 100. For example, when the above-described portable device 100 is embodied as smartphone, a base module further includes a location judgment module to judge GPS-based location, and a sensing module may further include a sensing module which detects movements of a user.

The communication device 130 has the configuration to communicate with various types of external devices according to various communication types. The communication device 130 may include various communication chips including e chip, Bluetooth chip, NFC chip, and wireless communication chip, etc. In this case, Wi-Fi chip and Bluetooth chip perform communication using Wi-Fi method, Bluetooth method, and NFC. Among these chips, NFC chip indicates a chip which operates in a type of NFC using 13.56 MHz bandwidth out of various bandwidths such as 135 kHz, 13.56 MHz, 433 MHz, 860˜960 MHz, and 2.45 GHz. In the case of using Wi-Fi chip or Bluetooth chip, a variety of connection information such as SSID and a session key are received or transmitted preferentially and then communication is conducted based on the received or transmitted connection information to receive and transmit various information. Wireless communication chip indicates a chip conducting communication based on various communication specifications such as IEEE, Zigbee, 3rd Generation (3G), 3rd Generation Partnership Project (3GPP), and Long Term Evolution (LTE), etc.

To be specific, to control the external device 200, the communication device 130 may perform paring with the external device 200. When pairing is performed, the communication device 130 may transmit a control signal to the external device 200 according to control of the controller 140.

The input 120 receives a user command to control overall operations of the portable device 100. In particular, the input 120, while maintaining a lock mode, may receive a user command to display a screen to release a lock mode or display the remote control UI.

In this case, the input 120 may be embodied as a button outside of the portable device 100, but this is merely exemplary, and input 120 may be embodied as another configuration which may control the portable device 100 such as a motion detector.

The controller 140 controls overall operations of the portable device 100 using various programs stored in the storage 190.

The controller 140, as illustrated in FIG. 3, includes RAM (141), ROM (142), a graphic processor 143, a main CPU 144, from 1 to n interface (145-1˜145-n), a bus 146. In this case, RAM 141, ROM 142, a graphic processor 143, main CPU 144, from 1 to n interface (145-1˜145-n), etc. may be connected to each other by using the bus 146.

In ROM 142, command sets for system booting may be stored. When a turn-on command is input and power is supplied, the main CPU 144 copies O/S stored in the storage 190 to RAM 141 according to a command stored in ROM 142 and executes O/S to boot system. When system is booted, main CPU 144 copies various application programs stored in the storage 190 to RAM 141, and runs application programs copied to RAM 141 to perform various operations.

The graphic processing unit 143, using a calculation unit (not illustrated) and a rendering unit (not illustrated), generates a screen which includes various objects such as an icon, an image, and a text. A calculation unit, using control command received from the input 130, calculates attribute values, where each object is to be indicated according to a layout of a screen, such coordinate, type, size, and color. A renderer, based on attribute values calculated by a calculation unit, generates a screen with various layouts which include objects. A screen generated by a rendering unit is displayed in a display area of the display 110.

Main CPU 144 controls accesses to the storage 190 and performs booting by using O/S stored in the storage unit 190. And, main CPU 144 performs various operations by using various programs, contents, and data stored in the storage 190.

From 1 to n interface (from 145-1 to 145-n) is connected with the afore-described components. One of the interfaces may be a network interface connected with an external device through network.

In particular, the controller 140, where there is no user command for a preset time (for example, 1 minute), the portable device 100 may be converted to a lock mode. In this case, during the lock mode of the portable device 100, power is only supplied for a limited number of elements (for example, the communication device and the input) to perform essential functions (such as wireless communication functions) of the portable device 100. Power may not be supplied for the functions other than essential functions (for example, the display). Accordingly, a lock mode of the portable device 100 may not display video.

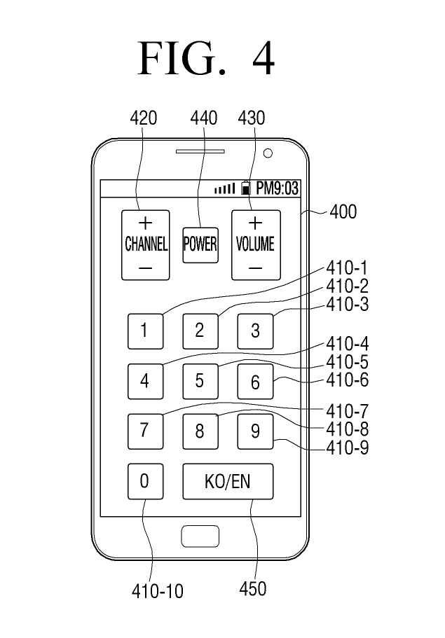

When a preset user command is input while the portable device 100 maintains a lock mode, the controller 140 may control the display 110 to display the remote control UI that may control the external device 200. For example, when the external device 200 is a TV and the portable device 100 maintains a lock mode, when a user command is input using a selected button on the portable device 100, the controller 140 may control the display 110 to display the remote control UI 400 which may control the TV as illustrated in FIG. 4. In this case, the remote control UI 400, as illustrated in FIG. 4, may include a plurality of number icons (from 410-1 to 410-10), a channel control icon 420, a volume control icon 430, a power icon (440), and a Korean/English conversion icon 450. However, the icons included in the remote control UI 400 as illustrated in FIG. 4 are merely exemplary, and other icons to control the TV (for example, a letter/number conversion icon, a mute icon, a letter icon, etc.) may be added.

The remote control UI may be provided differently according to the directions in which a user holds the portable device 100. For example, when a user holds a portable device in a vertical direction, the controller 140 may provide the remote control UI 400 as illustrated in FIG. 4. However, when a user holds the device in a horizontal direction, the controller 140 may provide the remote control UI in the form of a QWERTY keyboard.

In FIG. 4, it is illustrated that the external device 200 is a TV. However, this is merely exemplary, and the external device may be embodied as another electronic apparatus. In this case, when the external device 200 is embodied as another electronic apparatus other than a TV, the remote control UI also may include different icons. For example, when the external device 200 is an air-conditioner, the remote control UI may include icons to control an air-conditioner such as a temperature control icon, a wind direction control icon, and an automatic sleeping icon, etc.

Also, the controller 140, in order to control the external device 200 by using the remote control UI 400, may control the communication device 130 to perform pairing with the external device 200. Specifically, when a predetermined user command is input while a lock mode is maintained, the controller 140 may display the remote control UI, and search the external device 200 at the same time. When the external device 200 to be controlled is searched, the controller 140 may control the communication device 130 to transmit a signal to request pairing to the searched external device 200. In addition, when a signal responding to a signal requesting pairing is received from the external device 200, the controller 140 may conduct pairing with the external device 200. At this time, the controller 140, by performing pairing with the external device 200 using SSID and a password preset at the time of manufacturing, may automatically perform pairing with the external device 200 if the external device 200 and the portable device 100 are manufactured by the same manufacturer. However, the above-described pairing type is merely exemplary, and the portable device 100 may perform pairing with the external device 200 by using another method.

When the searched external device 200 is a device to be paired with the portable device for the first time, the controller 140 may control the display 110 to display a message asking whether to perform pairing with the initially searched external device to a user.

When a plurality of external devices are searched, the controller 140 may control the display 110 to display a list including a plurality of external devices, and when one of displayed plurality of external devices is selected, the controller 140 may perform paring with the selected external device. For example, when a TV and an air-conditioner are searched, the controller 140 may control the display 110 to display a list including the searched TV and the searched air-conditioner. In addition, when an air-conditioner is selected between the TV and the air-conditioner included in a list, the controller 140 may perform pairing with an air-conditioner. At this time, the controller 140 may change the displayed remote control UI to the remote control UI which may control selected external device.

When a plurality of external devices are searched, the displaying of the list by the controller 140 is merely exemplary, and even if a plurality of external devices are searched, the controller 140 may perform pairing preferentially with an external device designated by a user.

When pairing with the external device 200 is performed and a user command is input through the remote control UI, the controller 140 may control the communication device 130 to generate a control signal corresponding to the user command input through the remote control UI, and transmit a control signal to the external device 200. For example, when pairing with the TV is performed, if a channel up icon 420 is selected through the remote control UI 400, the controller 140 may control the communication device 130 to transmit a control signal corresponding to a channel-up command to the TV which is the external device 200.

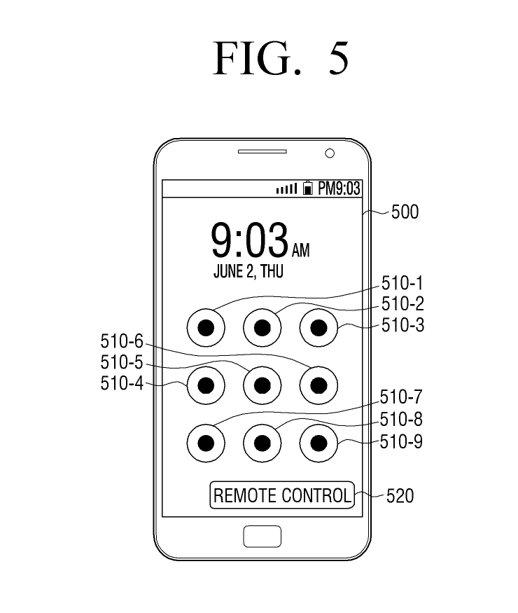

In an exemplary embodiment, it is explained that when a preset user command is input while a lock mode is maintained, the controller 140 controls the display 110 to directly display the remote control UI 400, but this is merely exemplary, and the controller 140 may control the display 110 to display a screen to release a lock mode preferentially. In this case, the controller 140 as illustrated in FIG. 5, may control the display 110 to display an icon 520 to generate the remote control UI along with a screen to release a lock mode 500 including a plurality of icons (from 510-1 to 510-9). In this case, when the icon 520 is selected, the controller 140 may display the remote control UI 400 and perform pairing with the external device 200 as illustrated in FIG. 4. The case where the remote control UI 400 is displayed preferentially as illustrated in FIG. 4, and the case where a screen to release a lock mode including an icon to generate the remote control UI 400 is displayed preferentially as illustrated in FIG. 5 may be determined according to a setting of a user.

The remote control UI (400) may not only perform a function to control the external device 200 but also a function to release a lock mode. Specifically, when a user command to release a lock mode using the remote control UI 400 is input, the controller 140 may control the display 110 to release a lock mode of the portable device 100 and display an execution screen.

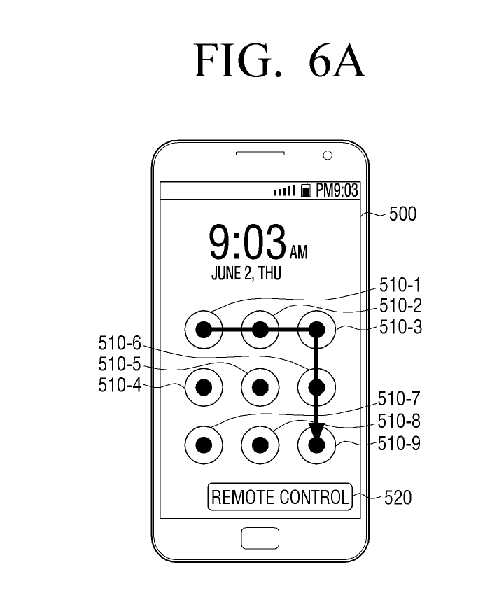

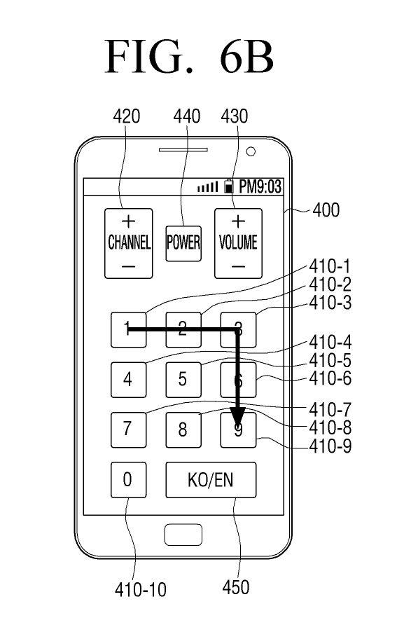

Specifically, when a user touch with a preset pattern is input into a number icon of the remote control UI, the controller 140 may control the display 110 to release a lock mode of the portable device 100 and display an execution screen. For example, when a general screen to release a lock mode is displayed, as illustrated in FIG. 6A, when touches of a first icon 510-1, a second icon 510-2, a third icon 510-3, a sixth icon 510-6, and a ninth icon 510-9 are input sequentially, the controller 140 may control the display 110 to release a lock mode of the portable device 100 and display an execution screen. Likewise, when the remote control UI 400 is displayed, as illustrated in FIG. 6B, when touches of “number 1” icon 410-1, “number 2” icon 410-2, “number 3” icon 410-3, “number 6” icon 410-6, and “number 9” icon 410-9 are input sequentially, the controller 140 may control the display 110 to release a lock mode of the portable device 100 and display an execution screen. In other words, even though the remote control UI 400 is displayed preferentially, a lock mode may be released by inputting the pattern which is the same as the pattern to release a lock mode of a general screen to release a lock mode.

When a plurality of number icons (from 410-1 to 410-10) are included, if a preset password is input into the remote control UI 400 through a number icon of the remote UI (400) as illustrated in FIG. 4, the controller 140 may control the display 110 to release a lock mode of a portable device and display an execution screen.

In addition, to selectively perform a function to control an external device and a function to release a lock mode through the remote control UI 400, the controller 140 may control the display 110 to display an icon to perform a function to control the external device 200 and an icon to perform a function to release a lock mode on the remote control UI 400. For example, when an icon to perform a function to control the external device 200 is selected, the remote control UI 400 may perform a function to control the external device 200 only.

As described above, when a preset user command is input while the portable device 100 maintains a lock mode, a user may immediately control the external device 200 by displaying the remote control UI and perform a function to release a lock mode of the portable device 100.

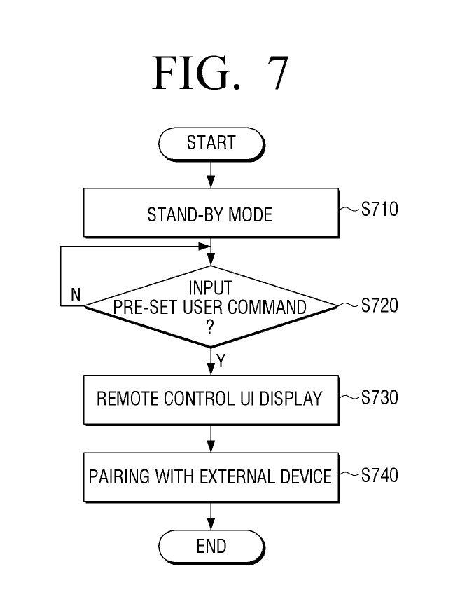

Hereinbelow, referring to FIG. 7, a method for the portable device 100 to control an external device 200 will be explained.

First of all, the portable device 100 maintains a stand-by mode (operation S710). At this time, the stand-by mode of the portable device 100 is a mode which is converted when a user command is not input for a preset time. In this case, power is supplied to a limited number of elements configurations (for example, a communication device, an input, a controller, etc.) to perform essential functions of the portable device 100. However, power may not be supplied to other elements (for example, a display).

While the portable device 100 maintains a stand-by mode, the portable device 100 determines whether a preset user command is input (operation S720). In this case, a preset user command may be user command to select a button installed outside of the portable device 100.

When a preset user command is input (operation S720-Y), the portable device 100 displays remote control UI (operation S730). At this time, remote control UI is a UI to control the external device 200. For example, when the external device 200 is a TV, the remote control UI as illustrated in FIG. 4 may be provided. In particular, according to an exemplary embodiment, the remote control UI not only performs a function to control the external device 200, but may also perform a function to release a lock mode as illustrated in FIGS. 3, 6A, and 6B.

The portable device 100 performs pairing with the external device 200 (operation S740). Specifically, the portable device 100 may search an external device to be controlled, transmit a signal requesting pairing to the searched external device, and perform pairing with the external device 200 when a signal responding to a signal requesting pairing is received.

As explained above, by a method of the portable device 100 to control an external device, a user may immediately control an external display device such as a TV by using a portable device.

FIG. 7 illustrates that operations S730 and S740 are operated sequentially. However, this is merely exemplary, and thus operations S730 and S740 may be embodied at the same time, or operation S740 may be performed preferentially.

A method for controlling an external device of a portable device according to the above-described exemplary embodiments may be embodied as a program and be provided to a display device.

Specifically, when a preset user command is input while the portable device maintains a lock mode, a non-transitory computer readable medium where a program comprising displaying the remote control UI to control an external device; and performing pairing with the external device to control the external device using the remote control UI is stored may be provided.

A non-transitory computer readable medium indicates a medium, not a medium storing data for short time such as a register, cash, and memory, which stores data for semi-permanently and is readable by machinery. Specifically, the above-described various applications or programs may be stored in a non-transitory computer readable medium such as CD, DVD, a hard disk, Blue Ray disk, USB, a memory card, ROM, and be provided.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method for controlling an external device of a portable device, the method comprising:
displaying a remote control user interface (UI) for controlling the external device when a preset user command is input while the portable device is in a lock mode; and
performing a pairing with the external device to control the external device based on the remote control UI.

2. The method of claim 1, further comprising:
when a user command is input to release the lock mode based on the remote control UI, releasing the lock mode of the portable device and displaying an execution screen.

3. The method of claim 2, wherein the remote control UI comprises a number icon, and
wherein the displaying the execution screen comprises, when a user inputs a preset pattern into number icons of the remote control UI, releasing a lock mode of the portable device and displaying the execution screen.

4. The method of claim 2, wherein the remote control UI comprises a number icon, and
wherein, when a preset password is input into the remote control UI, a lock mode of the portable device is released, and the execution screen is displayed.

5. The method of claim 1, wherein the displaying comprises:
when a preset user command is input while the portable device is in a lock mode, an icon for displaying a lock mode release screen and the remote control UI is displayed; and
when the displayed icon is selected, the lock mode release screen of the portable device is changed to the remote control UI.

6. The method of claim 1, wherein the performing of the pairing comprises:
searching for an external device to be controlled by the portable device;
when the external device to be controlled is detected, transmitting a pairing request to the detected external device; and
when a signal responding to the pairing request is received from the detected external device, performing the pairing with the detected external device.

7. The method of claim 6, comprising:
when the detected external device is an external device that is searched for a first time, displaying a message inquiring whether to perform pairing with the external device.

8. The method of claim 6, wherein the performing comprises:
when a plurality of external devices are searched, displaying a list including the searched plurality of external devices; and
when one of the plurality of external devices on the list is selected, performing pairing with the selected external devices.

9. The method of claim 1, comprising:
when a user command is input into the remote control UI, transmitting a control signal corresponding to the user command to the paired external device.

10. The method of claim 1, wherein when the external device is a television (TV), the remote control UI comprises at least one of a number icon, a channel control icon, a volume control icon, and a power icon.

11. A portable device, the device comprising:
a communication device configured to communicate with an external device;
an input configured to receive a user command; and
a controller configured to control a display of the portable device to display a remote control user interface (UI) to control the external device when a preset user command is input through the input while the portable device is in a lock mode, and configured to control the communication device to perform pairing with the external device to be controlled based on the remote control UI.

12. The device of claim 11, wherein the controller, when a user command is input to release a lock mode of the portable device based on the displayed remote control UI, is configured to control the display to release the lock mode of the portable device and display an execution screen.

13. The device of claim 12, wherein the remote control UI comprises a number icon, and
wherein the controller, is configured to control the display to release a lock mode of the portable device and display an execution screen when a user inputs a preset pattern into number icons of the remote control UI.

14. The device of claim 12, wherein the remote control UI comprises number icons, and
wherein the controller, when a preset password is input into the number icons of the remote control UI, is configured to control the display to release the lock mode of the portable device and display the execution screen.

15. The device of claim 11, wherein the controller is configured to control the display, when a preset user command is input through the input while the portable device is in the lock mode, to display an icon for displaying a lock mode release screen and the remote control UI, and when the displayed icon is touched, to change a lock mode release screen of the portable device to the remote control UI.

16. The device of claim 11, wherein the controller is configured to control the display, when a preset user command is input, to search for the external device to be controlled, and when the external device to be controlled is detected, to transmit a pairing request to the detected external device, and when a signal responding to the pairing request is received from the detected external device, to perform pairing with the detected external device.

17. The device of claim 16, wherein the controller is configured to control the display, and when the detected external device is an external device which is searched for the first time, to display a message inquiring whether to perform pairing with the external device searched for the first time.

18. The device of claim 16, wherein the controller is configured to control the communication device, and
wherein when a plurality of external devices are searched, to the controller is configured to display a list including the searched plurality of external devices, and when one of the plurality of external devices on the list is selected, to perform pairing with the selected external devices.

19. The device of claim 11, wherein the controller is configured to, when a user command is input into the remote control UI, transmit a control signal corresponding to the user command to the paired external device.

20. The device of claim 11, when the external device is a television (TV), the remote control UI comprises at least one of a number icon, a channel control icon, a volume control icon, and a power icon.
